(19) United States
(12) Patent Application Publication
(10) Pub. No.: US 2008/0018184 A1
(43) Pub. Date: Jan. 24, 2008

(54) Device For Accomodating Peripheral Driving Components

(76) Inventors: Alexander Seufert, Unterpleichfeld (DE); Volker Schueren, Marktheidenfeld (DE)

Correspondence Address: MICHAEL J. STRIKER, 103 EAST NECK ROAD, HUNTINGTON, NY, 11743, US

(21) Appl. No.: 11/569,488

(22) PCT Filed: May 3, 2005
(86) PCT No.: PCT/EP05/04766

§ 371 Date: Nov. 21, 2006

(30) Foreign Application Priority Data
May 24, 2004 (DE) 10 2004 025 812.0

(51) Int. Cl. H02K 5/04; H02K 11/00

(52) U.S. Cl. 310/68 B; 310/68 R; 310/89

(57) ABSTRACT

Disclosed is an electric motor (3) comprising a system (4) for detecting the motor state and a motor supply system (10, not represented). The aim of the invention is to keep the dimensions of the outer contours of the whole system (1, 3) as small as possible when assembling the electronics (4, 2) and the motor. Said aim is achieved by the fact that a device (1) for accommodating the system (4) detecting the motor state encompasses at least one component (2) of the motor supply system.

The present invention relates to an electric motor according to the definition of the species in claim 1.

Those skilled in the art have addressed the housing of electrical components in or on the housing of a motor or a generator for quite some time. Publication DE 101 23 626 A1, e.g., describes a converter for electrical machines, in which case a capacitor which encloses the machine is provided; the bridge circuits are connected to the electrodes of the capacitor such that they are distributed around the circumference of the machine. The objective of the present invention is to provide a system which is easier to manufacture and requires less space. This solution was used, e.g., with a starter-generator to be installed between a transmission and an internal combustion engine, in the case of which the cross section of the motor was many times greater than its length. The disadvantage of this design is the fact that the capacitor surrounds the machine and therefore substantially influences the dimensions of the cross section.

A smaller cross-section is also often required, however. Miniaturization and decentralization are also being applied to an increasing extent in electrical drive technology. In this case, it is necessary to first integrate separate components such as motor inverters or motor converters or motor control devices in the motor itself. New solutions are required which meet the high requirements for small installation space.

The object of the present invention is to find a solution for realizing a combination of drive electronics and motor which is cost-favorable, space-saving, and realizable with minimal expenditure, so that the dimensions of the outer contours of the whole system are changed as little as possible.

This is attained by the fact that, with an electric motor with a motor state detection system and a motor supply system, a housing device for the motor state detection system includes at least one component of the motor supply system. It can be, e.g., an electrical or electromechanical component or device.

The motor supply system controls the motor windings with current of the suitable voltage and frequency, while the motor state detection system senses information about the characteristic motor data during operation using a suitable sensor system. The electrical component can be any electrical components of devices enclosed by the motor housing or located near it.

The dimensions of the outer contours of the whole system are determined by the motor housing itself, the housing device for the motor state detection system, and a suitable housing for the motor supply system. This housing can be located on the circumference of the motor housing (while utilizing the motor housing simultaneously to dissipate heat) or axially (on the brush- or B-side). To prevent the housing of the motor supply system from increasing the overall dimensions, the installation space which is available anyway in the housing of the motor state detection system is used to also accommodate at least one electrical component of the motor supply system. Minimal additional costs are generated as a result, and the realization expenditure stays within limits, since it is only necessary to ensure that the components are housed stably and that contacting is provided. The amount of additional space required to house the motor supply system is reduced depending on the amount of space available in the housing of the motor state detection system The edge length of a motor with integrated power electronics therefore becomes not much longer than that of a standard motor. An additional advantage results in terms of the thermal load of the components. Compared with the whole system of motor/motor supply system/motor state detection system, the motor state detection system is the coldest location. Since electrical components typically exhibit temperature-dependent behavior in terms of their tolerances and service life, the service life of components can be increased by using an inventive system.

The motor housing itself functions as a housing device for the motor detector, in that it is sized such that it can accommodate it, in addition to the stator and rotor. The advantage which results is a tightly sealed, connectionless design which encloses all components equally and entirely.

As an alternative, the housing device is a separate housing which is combined with the motor housing. This additional housing could be flange-connected on the B-side of the motor housing; it should be adapted to the outer contours of the motor, so that only its length changes and not its cross section. Defective components or a complete motor state detection system can therefore be replaced quickly.

The components are necessarily composed of at least one annular and/or cylindrical and/or rectangular body. With an annular design, the component could enclose at least part of the motor state detection system inside the housing. This ensures that components can be housed easily and space can be utilized in an optimal manner. Optimal use of space can also be attained using rectangular or cylindrical shapes. Components of this type are typically much less expensive to manufacture than the annular shape, which requires less material but is much more expensive. The available space could be utilized even better by using a suitable arrangement of individual components having various designs.

When the component with at least one connection for connecting a plug connector or a socket is enclosed by a frame which is designed as a common carrier—the frame including a coaxial recess—this frame be easily located around the motor state detection system—which is usually cylindrical in design—inside the housing itself. The coaxial recess thereby serves as a recess for housing the motor state detection system inside the frame. This would result in practical use of the available space inside the housing of the motor state detection system and a stable and easy-to-use holder for the components. The connection can serve to connect the motor windings to a multiphase power supply provided by a convertor or an inverter, and it can include the connections of the motor state detection and a detachable connector for the components. The frame can also serve as insulation against the housing—which is usually grounded—provided it is made of a non-conductive material, e.g., plastic. In addition to components and plug connectors, it is also possible to easily immobilize the lines required to connect the components using guides mounted on the frame. The frame is provided with a panel, the profile of which is identical with the cross section of the housing of the motor supply system. The panel then serves simultaneously as a cover for the housing of the motor supply system. If this cover is also provided with a seal, high requirements on the type of protection of the device can be met. The frame as such therefore performs multiple functions, i.e., it serves as insulation, a holding device, a cable guide, and a tight cover.

Advantageously, the component is located on the frame in the shape of a V. This design ensures that minimal space will be used, because the intermediate space between the motor state detection system and the inner housing wall is used optimally. A U-shaped design of three or more capacitors is also feasible. A rectangular, frame-type design around the motor state detection system is also favored. In this case, the frame is formed by blocking capacitors.

The present invention is particularly advantageous when the motor supply system includes a motor converter or motor inverter which is mounted on the motor housing and is therefore completely integrated with the motor, and the components are the intermediate circuit capacitance of the intermediate circuit. Other regulating devices installed near the motor could also utilize the available space for their components (e.g., inductivities, line filters, Y capacitors, and similar large-volume and/or heavy components). Energy is supplied to the converter using a direct-current intermediate circuit. The intermediate circuit capacitance serves to buffer and, particularly, to smooth out the intermediate circuit voltage, which was generated by rectifying the phases of a three-phase system and contains harmonic components. When the lines between the switch cabinet with SPC and motor are long, the inductivity of the intermediate circuit line can result in voltage spikes destroying the IGBTs in the integrated converter. It is therefore necessary to locate capacitance—of the appropriate dimensions—as close to the converter as possible, because it is low-inductance. This capacitance, which can be realized, e.g., using one or more electrolyte capacitors, also has considerable dimensions, depending on the design, and therefore requires a great deal of installation space.

The present invention provides this installation space without increasing the outer contour of the motor. The service life of the intermediate circuit capacitor also depends considerably on the ambient temperature to which it is exposed. The service life is increased by the fact that the housing is installed near the motor state detection system and is not near from the motor windings, which become very hot during operation.

For the reasons stated above, the temperature resistance and, therefore, the service life, can be increased even further by using foil capacitors instead of electrolyte capacitors. Water cooling or forced air cooling or a mix of the two can therefore be eliminated. Foil capacitors also typically have larger dimensions. The present invention provides the amount of space required to house these valuable capacitors.

The motor state detection is preferably a feedback device for reporting speed and/or the position and/or the direction of rotation to a drive controller and/or a higher-order control device. This feedback device could be, e.g., a device which operates using optical methods, which could function, e.g., according to the multiturn principle. Devices of this type are often used in combination with asynchronous machines/synchronous machines which are controlled in a three-phase manner using drive controllers via an intermediate circuit and an inverter. They are typically used to drive servo axes and main spindle drives. The requirements on the dimensions are often very strict in this case, since generators/motors of this type must be housed in machines, on which very high requirements are also placed in terms of dimensions (machine tools, automation lines, printing presses, etc.).

Advantageously, the component could be a line inductor or a line filter, because these components are usually very large and therefore require a great deal of installation space, which would also have to be provided.

A few embodiments and basic potential designs of capacitances will be presented schematically below. Identical components are have identical reference numerals.

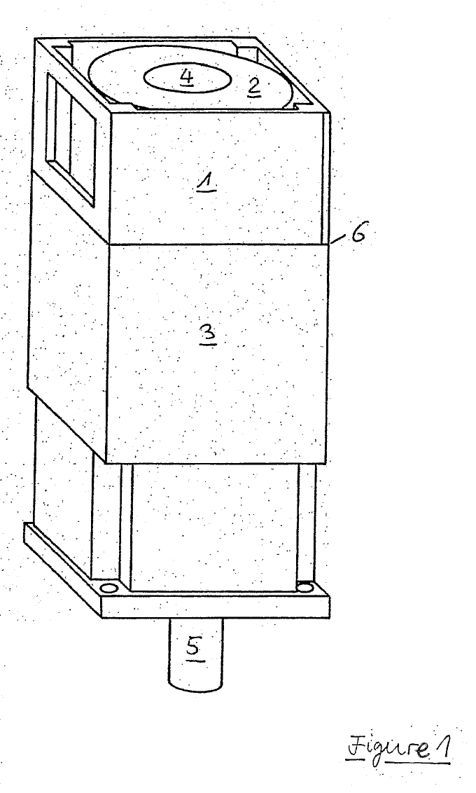

All FIGS. 1 through 3 show housing device 1, capacitance 2, motor housing 3, motor state detection system 4 and space 4a provided therefore, drive 5 and seam 6.

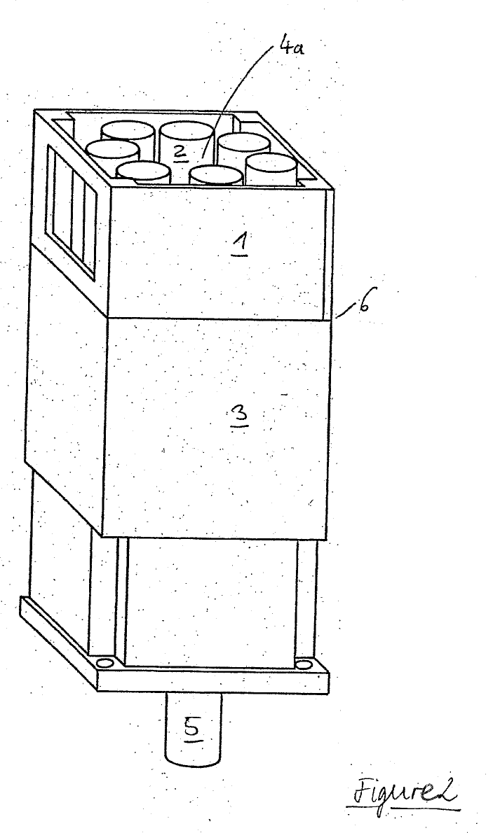

Housing device 1, which is shown opened, is flange-mounted on the brush- or B-side on motor housing 3. The flange mounting results in seam 6, which can be sealed against external influences using a suitable device. It is also be feasible to design the motor housing with an extension, so that seam 6 is eliminated and a hermetic seal of the internal components is easier to realize. Motor shaft, which functions as drive 5, is shown on the outer-side drive or A-side. Cover of housing device 1 is not shown, so the interior space can be seen. Round or square (FIGS. 2/3) capacitors 2 or a single annular capacitor 2 (FIG. 1) required to realize a desired capacitance are shown. Space 4a (FIG. 2) accommodates motor state detection system 4 (FIGS. 1/3), which is often circular or cylindrical in design. The optical sensors of the motor state detection system are operatively connected with motor shaft 5 and sense values such as speed, acceleration, and position. The space occupied by capacitors 2 would be unused if it were not for the present invention. The present invention makes it possible to utilize the space in a practical manner without changing the outer dimensions of whole system 1 and 3.

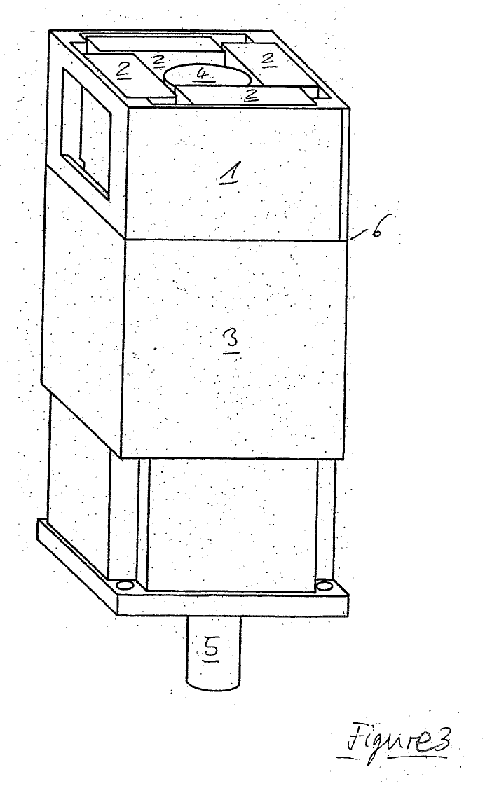

Annular capacitor 2 according to FIG. 1 ensures gapless utilization of the open space around the motor state detection system. Ring formed of individual cylindrical capacitors 2 and shown in FIG. 2 ensures that space is used with similar effectiveness; it can be realized at a much lower cost. The rectangular design of the motor state detection system shown in FIG. 3 is realized using economical blocking capacitors 2 and makes optimal use of the space between the outer walls of housing 1 and motor state detection system 4 even into the corners of the housing.

To optimize the space utilization even further, any other shapes of capacitors could also be combined, especially if higher capacitance values are required. For example, the space between blocking capacitors 2 and motor state detection system 4 (FIG. 3) could also be used for an annular capacitor or individual cylindrical capacitors arranged in the shape of a ring. Small, individual, cylindrical capacitors could also be accommodated in the corners of the housing.

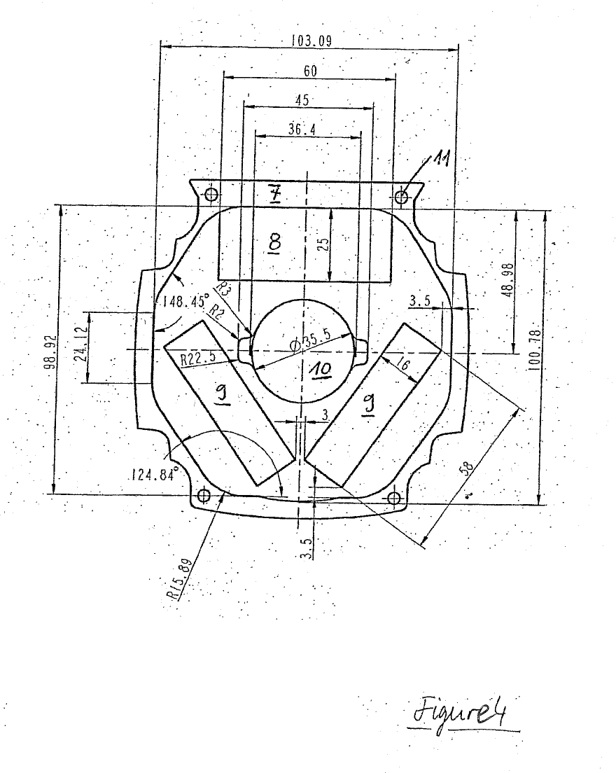

FIG. 4 shows the concrete realization of a frame-type carrier with fastening bores 11. Carrier 7 itself and recesses 8, 9 and 10 are shown.

Recess 8 serves to accommodate a plug connector or a coupling so that the intermediate circuit capacitance can be detachably connected with the direct-voltage intermediate circuit. V-shaped capacitor recesses 9 ensure that space is utilized effectively.

With housing 1 of the motor state detection system—the feedback system of a synchronous motor in this case—open (FIGS. 1 through 3), the frame is inserted from above and coaxially with motor state detection system 4 and motor shaft 5 such that the feedback enters recess 10 and, when the carrier is in the end position, it is surrounded by the capacitors which have been inserted in recesses 9. Carrier panel 1—which is preferably made of plastic—is attached to housing 1 using a suitable fastening material, such as screws and threaded bushings. The innerworkings of the feedback housing are protected against external influences via the cover, which is enclosed by the carrier. When a seal (e.g., an O-ring in a circumferential groove in the carrier) is used, the system is water-tight. IP protective systems>65 can therefore be realized easily.

Frame shown in FIG. 4 is sized such that it can accommodate two foil capacitors—which are connected in parallel—with a total capacitance of 24 μF. The two capacitors are sized such that the system delivers good smoothing results depending on the permanent inverter performance and the maximum permissible voltage dip if a brief overload occurs and/or during normal operation. Capacitors can be connected in any manner (in parallel/in series), of course. This configuration is used with a synchronous machine with a maximum speed of 3000 rpm with a torque of approximately 6 Nm and a permissible peak effective current of 15 amperes per phase.

### LIST OF REFERENCE NUMERALS

1 Housing device
2 Capacitance(s)
3 Motor housing
4 Motor state detection system
4a Space for motor state detection system
5 Motor shaft
6 Housing seam
7 Carrier frame panel with cover
8 Recess for electrical connection
9 Recess for capacitor
10 Recess for feedback circuit
11 Bore(s)

What is claimed is:

1. An electric motor with motor state detection system (4) and motor supply system,
wherein
a housing device (1) for the motor state detection system (4) includes at least one component (2) of the motor supply system.

2. The electric motor as recited in claim 1,
wherein
the housing device (1) is the motor housing (3) itself.

3. The electric motor as recited in claim 1,
wherein
the housing device (1) is a separate housing which can be combined with the motor housing (3).

4. The electric motor as recited in claim 1, wherein
the component (2) is formed of at least one annular and/or cylindrical and/or rectangular body.

5. The electric motor as recited in claim 1,
wherein
the component (2) and at least one connection are enclosed by a frame (7) designed as a common carrier; frame (7) includes a coaxial recess (10).

6. The electric motor as recited in claim 5,
wherein
the component (2) is located on the frame (7) in the shape of a V.

7. The electric motor as recited in claim 1, wherein
the motor supply system includes a converter or an inverter, and the component (2) is the intermediate circuit capacity of an intermediate circuit.

8. The electric motor as recited in claim 7,
wherein
the intermediate circuit capacity (2) is realized using at least one foil capacitor.

9. The electric motor as recited in claim 1, wherein
the motor state detection system (4) is a feedback device for reporting speed and/or position and/or the direction of rotation to a motion controller and/or a motion regulator.

10. The electric motor as recited in claim 1,
wherein
the component (2) is a line inductor or a line filter.
